(19) United States
(12) Patent Application Publication
(10) Pub. No.: US 2025/0069140 A1
(43) Pub. Date: Feb. 27, 2025

(54) SYSTEMS AND METHODS FOR TRANSFORMING OPTION ATTRIBUTES FOR RISK ANALYSIS, DIRECTIONAL FORECASTING, AND GENERATING PERSONALIZED TRADE IDEAS

(71) Applicant: OptionColors, Inc., San Francisco, CA (US)

(72) Inventor: Morris Donald Scott PUMA, San Francisco, CA (US)

(21) Appl. No.: 18/945,413

(22) Filed: Nov. 12, 2024

Related U.S. Application Data
(63) Continuation-in-part of application No. 18/126,980, filed on Mar. 27, 2023.

(51) Int. Cl. G06Q 40/04

(52) U.S. Cl. CPC G06Q 40/04

(57) ABSTRACT

The present invention provides systems and methods for enhancing options trading by applying customized formulas to options attributes such as implied volatility (IV), Greeks, and option prices. By transforming traditional options data through user-defined or preset formulas, the invention generates new analytical insights displayed via innovative interfaces. These interfaces allow investors to visualize transformed data, predict market movements, identify favorable trading opportunities, and construct optimized trading strategies. The system incorporates tools for real reversion and continuation modeling, statistical risk assessment, and an artificial intelligence module that generates personalized trade ideas based on historical data and user preferences. This comprehensive approach enables more informed decision-making, improves trading outcomes, and offers significant advantages over prior art in options analysis and trading.

### CROSS-REFERENCE TO RELATED APPLICATIONS

The present application U.S. patent application Ser. No. 18/126,980, which claims priority under 35 USC 120 as a continuation to U.S. patent application Ser. No. 16/246,561 filed Jan. 14, 2019, which claims priority under 35 USC 120 as a continuation-in-part application to U.S. patent application Ser. No. 15/956,737, filed Apr. 18, 2018, which claims priority under 35 USC 119(e) to U.S. Provisional Application No. 62/486,788, filed Apr. 18, 2017; this application also claims priority under 35 USC 120 as a continuation-in-part application to U.S. patent application Ser. No. 15/272,378, filed Sep. 21, 2016, which is a continuation of U.S. patent application Ser. No. 14/540,035, filed on Nov. 12, 2014, now abandoned, which is a continuation-in-part of U.S. application Ser. No. 14/312,662, filed on Jun. 23, 2014, now abandoned, which claims priority under 35 USC 119(e) to U.S. Provisional Application No. 61/837,634, filed Jun. 21, 2013; the '035 application also claims priority under 35 USC 119(e) to U.S. Provisional Application No. 61/902,758, filed on Nov. 11, 2013, and U.S. Provisional Application No. 61/902,760, filed on Nov. 11, 2013; this application further claims priority under 35 USC 120 as a continuation-in-part application of U.S. patent application Ser. No. 15/489,726, filed Apr. 17, 2017, which is a continuation-in-part of Ser. No. 15/272,378, filed Sep. 21, 2016, which is a continuation of the '035 application; and U.S. patent application Ser. No. 15/489,726, also claims priority under 35 USC 119(e) to U.S. Provisional Patent Application Nos. 62/323,571, filed Apr. 15, 2016, 62/337,394, filed May 17, 2016 and 62/337,407, filed May 17, 2016, the contents of each herein listed document being hereby incorporate by reference in their entirety.

### BACKGROUND OF THE INVENTION

### 1. Field of the Invention

The invention relates generally to computer hardware and distributed computer networks, and more specifically, to a remote options server to assist options traders in constructing options positions superimposed over visual, formula-applied options' implied volatilities (IV) or any other formula-applied options' attributes such as, without limitation, historical data, statistics, option Greeks, options expiries, option prices, underlying prices, IV changes and price changes. By applying formulas to options attributes, investors gain insight as to which options are beneficial to buy and sell, insights which are otherwise unavailable.

### 2. Description of Related Art

Options are complex and some of their attributes include option Greeks, IV option prices, days to expiration and the price of the underlying. Price changes of options are affected by many aspects such as moneyness, days to expiration, changes in time, IV, underlying price moves, interest rates, liquidity and pending news, just to name a few. Since so many things affect an option's price, the exact future value of an option is unpredictable.

Since the exact future price of an option is difficult to forecast, methods are in demand to calculate future options pricing as accurately as possible. Additionally, methods are needed to forecast market behavior more accurately, and methods are also needed to help a trader know exactly which options to buy and sell at any given moment. There are nearly an infinite number of option combinations a trader can construct. and constructing the most optimized options positions for consistent success is difficult.

Currently, the majority of options traders construct option trades based on days to expiration, liquidity, theta, gamma, delta and vega. However, the majority of traders do not optimize their trades for volatility reversion per strike because the required information for optimization is not available to them. Most traders, unknowingly, are consistently entering trades at the wrong time and with a poor structure for their existing environment.

A put back-ratio comprises 2 put options, a short and a long with more long contracts than shorts. A trade configuration could be BUY 2 puts at the −0.10 delta and SELL 1 put at the −0.20 delta. If a trader enters this trade with a negative formula-applied volatility skew, meaning the long contract has a higher formulated volatility than the short contract, then this trade will be at a disadvantageous price. This is because the trader is “buying high and selling low”, which is detrimental to the trade. The traditional option chain does not display formula-applied volatility per strike to the investor, so the investor does not understand this. In this situation the trader is at a loss from the get-go of the trade, and during the life of the trade, if the volatility skew reverses, meaning the formulated IV of the short contract increases relative to the long contract, a drawdown will most likely occur on the trade.

Options traders are making trading mistakes each day because current software does not provide traders with a method to compare option contracts to each other, and the result is traders buy and sell options at disadvantageous prices over and over.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present invention provides a system and method that is configured to enhance options trading by applying customized formulas to options attributes such as implied volatility (IV), Greeks, option prices, and days to expiration. By transforming traditional options data through user-defined or preset formulas, the invention generates new analytical insights that are displayed via innovative user interfaces. These interfaces enable investors to visualize transformed data in ways not possible with prior art, allowing them to identify favorable trading opportunities, predict market movements, and construct optimized trading strategies.

It is a particular objective of the present invention to provide a system which is configured to allow investors to apply custom formulas to options attributes, transforming the data to reveal hidden patterns and opportunities. This includes the ability to rank IV values, compare ATM and OTM IV skews, and analyze options based on custom metrics derived from Greeks and other attributes.

It is another objective of the present invention to provide various interfaces such as formula input interfaces, grid displays with superimposed risk profiles, volatility skew charts, and statistical probability interfaces. These interfaces enhance the visualization and analysis of the transformed data, making complex information accessible and actionable.

It is yet another object of the present invention to provide tools for real reversion modeling and continuation pattern modeling to allow investors to assess potential profit and loss impacts based on historical and projected data. The system enables users to model scenarios where options attributes revert to historical means or continue along current trends.

It is another object of the present invention to provide statistical risk assessment by integrating statistical analysis into options risk modeling, the invention provides investors with insights on volatility and price movements per strike. This allows for precise risk management under various market scenarios, including market crashes, earnings releases, or economic downturns.

It is another objective of the present invention to provide an artificial intelligence module configured to track user trading activity and generate personalized trade ideas based on historical data, formula-applied attributes, and user preferences. This enhances the investor's ability to identify profitable trades aligned with their trading style.

It is yet another object of the present invention to provide implied volatility predictions for forecasting changes in implied volatility over specified time frames, calculating the probability of IV moving up or down. It also tracks the accuracy of these predictions, allowing users to assess and trust the system's forecasting capabilities.

In order to do so, in one aspect of the invention, a computer-implemented method for enhancing options trading is provided, comprising steps (a) receiving, by a computing system, options data including options attributes for a plurality of options contracts; (b) calculating, by the computing system, options attributes including implied volatility values and Greeks for the plurality of options contracts using an options pricing model; (d) applying, by the computing system, a user-defined or preset formula to at least one options attribute to generate transformed options data; (e) storing, by the computing system, the transformed options data in a database; (f) generating, by the computing system, at least one graphical user interface that displays the transformed options data, wherein the interface includes interactive elements allowing a user to visualize and analyze the transformed options data across different options contracts and expirations; (g) analyzing, by the computing system, patterns in the transformed options data to identify trading opportunities and predict market movements; and (h) providing, by the computing system, trade recommendations or strategies to the user based on the analysis of the transformed options data.

The foregoing has outlined rather broadly the more pertinent and important features of the present disclosure, so that the detailed description of the invention that follows may be better understood, and so that the present contribution to the art can be more fully appreciated. Additional features of the invention, which will be described hereinafter, form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE DRAWINGS

Other features and advantages of the present invention will become apparent when the following detailed description is read in conjunction with the accompanying drawings, in which:

FIG. 1 is a high-level block diagram of an example network communication system according to conventional options analytics.

FIG. 2 is a high-level block diagram of an example network communication system including a formula input module, a formula-applied implied volatility database, and an options trade ideas generation system, according to the principles of the present disclosure.

FIG. 3 is a functional block diagram of an example implementation of a trade generation system of the present disclosure.

FIG. 4 is a functional block diagram of an example implementation of a term-structure chart generation system, as depicted in FIG. 7, of the present disclosure.

FIG. 5 is a continuation of FIG. 4, a functional block diagram of an example implementation of a trade generation system based on a formulated volatility comparison system per option, of the present disclosure.

FIG. 6 is a functional block diagram of an example implementation of a method to process probabilities from statistics for an options position, as depicted in FIG. 18 and FIG. 19, of the present disclosure.

FIG. 7 is an example user interface of a term structure chart generation system according to the principles of the present disclosure.

FIG. 8 is an example user interface of a formula-applied volatility skew chart according to the principles of the present disclosure.

FIG. 9 is an example user interface of a volatility skew chart according to the principles of prior art.

FIG. 10 is an example user interface of a formula-applied volatility skew chart according to the principles of the present disclosure.

FIG. 11 is an example user interface to apply formulas to options' attributes and/or create formulas with options' attributes, according to the principles of the present disclosure.

FIG. 12 is an example user interface that displays the output of a formula, as shown in FIG. 11, applied to a plurality of options' attributes, according to the principles of the present disclosure.

FIG. 13 is an example user interface displaying the output of a formula, as shown in FIG. 11, that is applied to a plurality of options' attributes and is superimposed with a risk profile, according to the principles of the present disclosure.

FIG. 14 is an example user interface that shows the historical output of a formula-applied IV, as input through the FIG. 11 interface, modeling the impact of a reversion pattern on profits and losses, according to the principles of the present disclosure.

FIG. 15 is an example user interface displaying the historical output of a formula-applied IV, as input via FIG. 11, modeling the impact of a continuation pattern on profits and losses, according to the principles of the present disclosure.

FIG. 16 is an example user interface illustrating the historical output of a formula-applied IV, as input in FIG. 11, modeling the effects of weighted-reversion or weighted continuation patterns on profits and losses, according to the principles of the present disclosure.

FIG. 17 is an example user interface displaying the high, low, and average output of a formula-applied IV, as input in FIG. 11, modeling the profits and losses derived from reversion or continuation of the formula per option strike, according to the principles of the present disclosure.

FIG. 18 is an example user interface that integrates statistics with a risk profile, as described in FIG. 5 and FIG. 6, according to the principles of the present disclosure.

FIG. 19 is an example user interface that allows the user to select historical data sets from an options database, as depicted in FIG. 6, according to the principles of the present disclosure.

FIG. 20 is an example user interface that generates trade ideas for a user based on artificial intelligence principles, reversion and continuation calculations, according to the principles of the present disclosure.

FIG. 21 is an example user interface predicting changes in implied volatility per underlying asset according to the principles of the present disclosure.

FIG. 22 is an example user interface calculating the success rate of implied volatility reversion and continuation predictions, according to the principles of the present disclosure.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein to specifically provide superimposing an options risk profile over formula-applied options' attributes to maximize returns for investors.

It is to be understood that the terminology used herein is for the purpose of describing particular embodiments only and is not intended to be limiting. The terms “a” or “an,” as used herein, are defined as to mean “at least one.” The term “plurality,” as used herein, is defined as two or more. The term “another,” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time. These terms generally refer to a range of numbers that one of skill in the art would consider equivalent to the recited values (i.e., having the same function or result). In many instances these terms may include numbers that are rounded to the nearest significant figure.

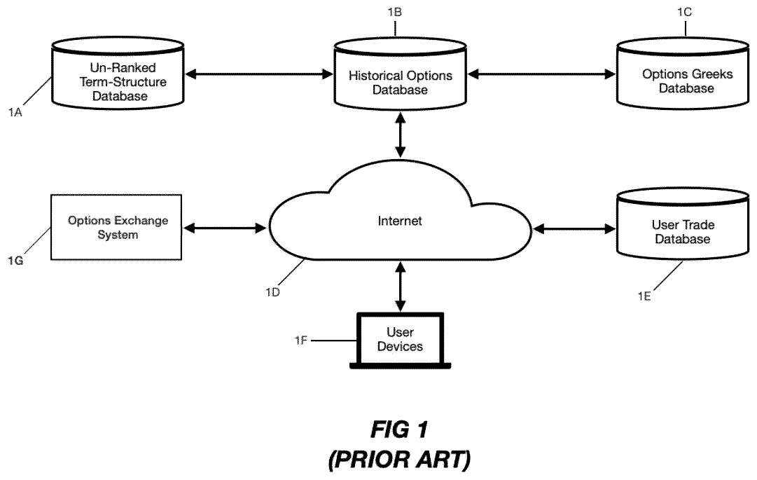

Referring now to FIG. 1, the prior art depicts a conventional options trading system where user devices (1F) communicate with an options exchange system (1G) via a communication network such as the Internet (1D). Investors use their devices (1F) to access live data or a historical options database (1B), options Greeks (1C), and a user trade database (1E). As well known in the art, the option Greeks include but are not limited to Delta, Gamma, Theta, Vega, and Rho. They analyze the risk of their investment portfolios by interacting with these databases (1A, 1B, 1C, and 1E). There is an opportunity to provide an improvement to conventional options trading systems and methods that will be described in further details below.

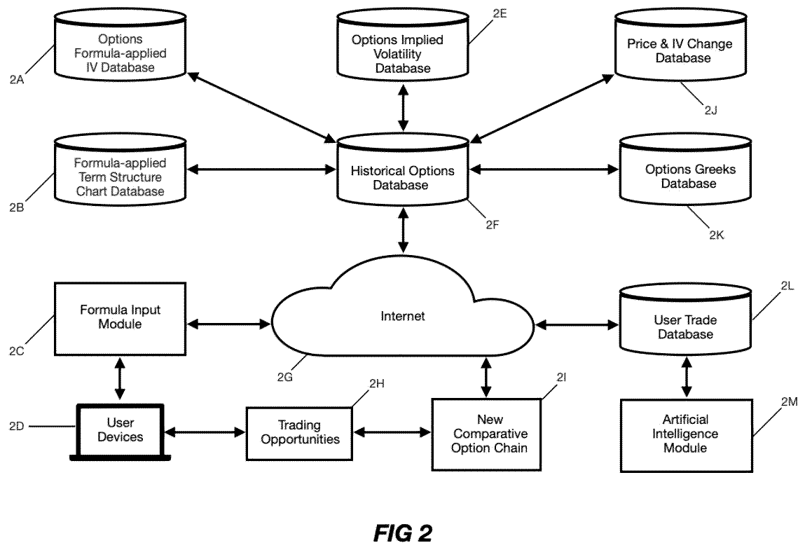

Referring now to FIG. 2, the present invention enhances the traditional system by processing the historical options database (2F) through the application of customized formulas via the Formula Input Module (2C) to options attributes like Greeks via options Greeks Database (2K), IV via Implied Volatility Database (2E), and price and IV changes via Price & IV Change Database (2J). This processing generates transformed data that provides investors with insights unavailable in prior art, enabling them to identify which options to buy or sell more effectively.

Still referring to FIG. 2, an options formula-applied implied volatility database (2A) is created by applying a formula to the original IV values (2E) of the historical options database (2F). Advantageously, by modifying the original IV values, investors gain a new perspective on how IV levels relate to each other and to the underlying asset. Each option's IV is adjusted to reflect its current level compared to a defined historical period (e.g., the last 30 days). This transformation allows investors to quickly identify unusually high or low IVs, which are directly correlated to option prices. Consequently, the system aids in spotting high and low option prices, enhancing trading decisions and helping prevent disadvantageous trades. It should be understood that the defined historical period may be selected by the user to a number of preset options, including custom time periods.

In some embodiments, an options implied volatility database (2E) is provided and is derived from the historical options database (2F). Historical or live options data may be acquired through various methods, including API connections to brokerages. Additionally, an options Greeks database (2K) is maintained, where Greeks are calculated using an options pricing model-such as the Black-Scholes model—applied to the historical options data (2F). This database may include Greeks such as Delta, Gamma, Theta, Vega, Vomma, Vanna, Lambda, Charm, Color, Ultima, among others, without limitation to the types of Greeks that may be stored or utilized in the invention.

Each option has an associated IV value determined through an options pricing model. There is a direct correlation between an option's implied volatility and its price; as the implied volatility fluctuates upward or downward, the option's price adjusts accordingly. Understanding whether the IV value is relatively high or low provides critical insight into the option's price status. However, in the conventional format of IV, an investor is unable to readily discern whether an IV is high or low relative to other values. Therefore, it is advantageous for an investor to apply a formula to the IV value to reformat it, thereby enhancing visibility into whether the option's price is at a high or low point.

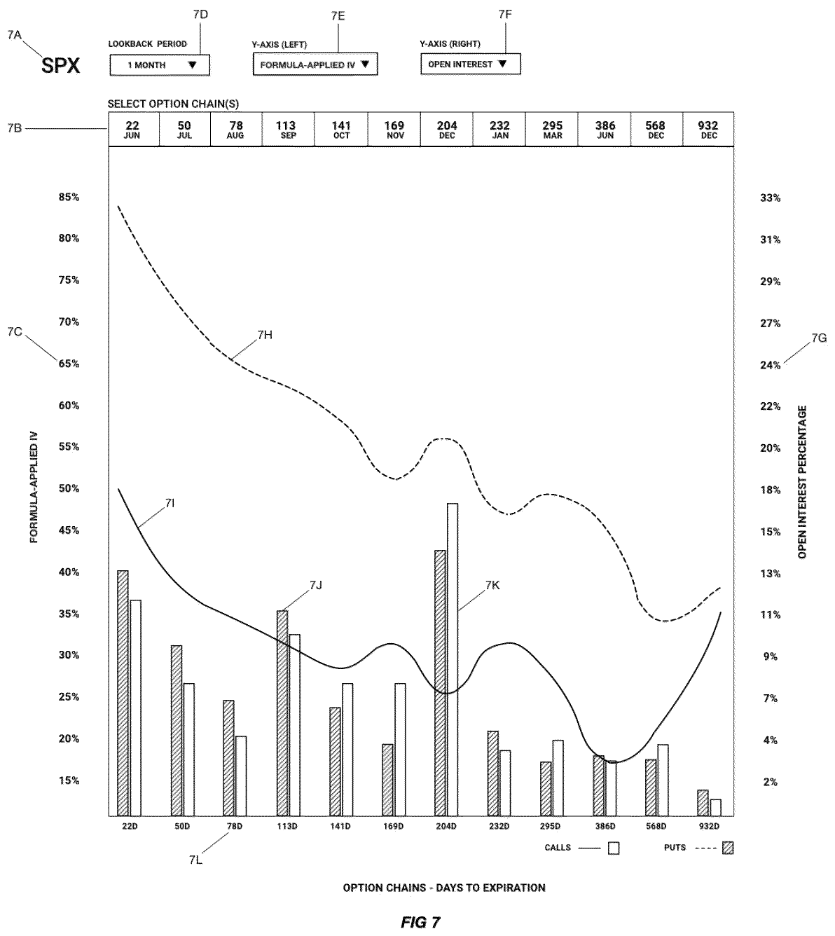

In some embodiments, the invention maintains an IV database (2E), which is utilized to create the formula-applied options IV database (2A). This database generates the formula-applied IV term-structure database (2B). While the invention is not limited to any specific formula, a sample ranking method is described. The formula-applied IV term-structure interface, as shown in FIG. 7, serves multiple purposes: it can predict price action or highlight favorable option expirations for buying or selling. This will be explained in further details below.

In FIG. 7, when the formula-applied IV of Put options (dashed line) is above that of Call options (solid line), the sentiment is bearish, indicating higher investor interest in purchasing Puts over Calls. Specifically, if the formula-applied IV of Puts is higher in the short-term months, it suggests near-term bearish sentiment. Conversely, when the formula-applied IV of Calls exceeds that of Puts, the market sentiment is bullish. The greater the separation between the lines, the stronger the market sentiment. This dual-line representation and the formula-applied IVs provide insights not present in the prior art term structure charts, which typically display a single line representing both Calls and Puts without applying a formula to IVs.

Still referring to FIG. 2, in some embodiments, the database of price and IV changes (2J) is also used to generate directional signals for the underlying asset—bearish, neutral, or bullish. By combining data from databases (2J) and (2B), the system identifies statistical patterns that correlate with directional market movements. For instance, a study may reveal that when the formula-applied Call IV line crosses above the formula-applied Put IV line after a sustained period of the opposite condition, and the difference between Calls and Puts meets a specific threshold along with a minimum number of expirations, a reversal from bearish to bullish sentiment occurs with over 90% accuracy.

In some embodiments, an artificial intelligence (AI) module (2M) is provided, and configured to track a user's trading activity (2L) and generates personalized trading opportunities (2H) aligned with the user's preferences. This module integrates directional predictions derived from databases (2J) and (2B), as well as IV reversion and continuation patterns for each option from database (2A). The AI module enhances the user's ability to identify profitable trades tailored to their trading style.

Yet still referring to FIG. 2, a New Comparative Option Chain (2I) is provided, which enables the user to output the applied formula to option Greeks or any other option attribute. Instead of constructing an options trade using the traditional option chain (as in prior art), investors can now base their trading decisions on custom formula-applied option chains or those embedded within the software platform. This provides a more nuanced approach to trade construction by focusing on transformed data that highlights potential opportunities.

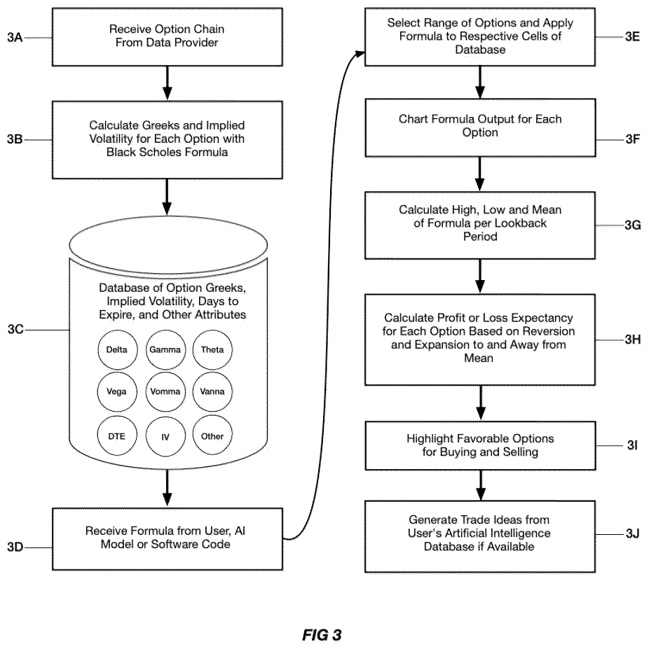

FIG. 3 is a functional block diagram of an example implementation of a trade generation system of the present disclosure. Referring now to FIG. 3, in step (3A), the software receives an option chain from a data provider. In step (3B), the system calculates option attributes using the Black-Scholes Formula or another options pricing model/formula. In some embodiments, in step (3C), the calculated attributes are stored in a database for further processing. In step (3D), a selected options attribute is transformed by applying a formula, which may be provided or received by the user, an artificial intelligence model, or a software code. In step (3E), the user selects a range of options to display their respective formula-applied attributes. In step (3F), the software generates the formula's output into a chart for visualization. For a look-back period, such as 30 days, in step (3G), the formula is applied to the chosen options attribute, and the high, low, mean, and current levels are stored or cached. In step (3H), the system calculates profits and losses for each option based on its reversion to the mean or continuation away from the mean. If a favorable trade opportunity is identified, in step (3I), it is highlighted for the investor. Finally, in step (3J), a trade idea is generated based on the analysis.

The present invention offers significant advantages for investors by providing enhanced analytical tools that transform traditional options data into actionable insights. By applying custom formulas to options attributes such as implied volatility, Greeks, and prices, the system uncovers hidden patterns and opportunities not visible in prior art. This enables investors to make more informed trading decisions, optimize their strategies based on precise risk modeling and statistical analysis, and improve trading outcomes.

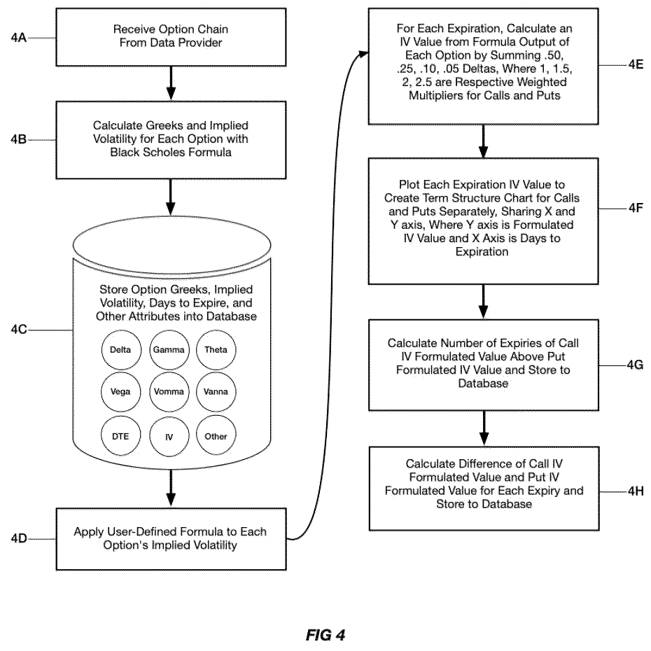

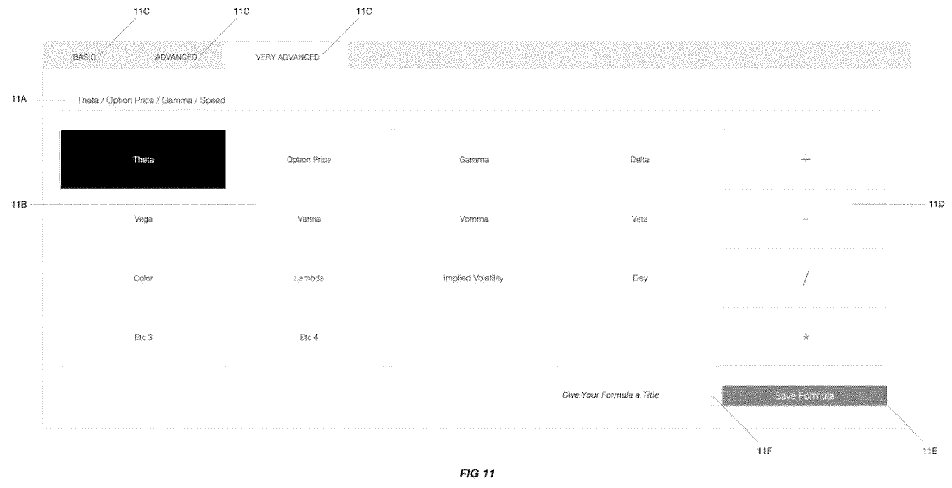

FIG. 4 is a functional block diagram illustrating an embodiment where a formula is applied to the implied volatility (IV) of each option, generating a transformed term-structure chart used to predict price action and identify favorable options expiries. Referring now to FIG. 4, in step (4A), the software receives an option chain from a data provider. In step (4B), the system calculates necessary attributes such as Greeks, IV, and option prices using the Black-Scholes formula or another pricing model. In some embodiments, in step (4C), these calculated attributes are stored in a database for further processing. In step (4D), a formula is applied to each option's implied volatility. In some embodiments, this formula may be predefined within the software or provided by the user through an interface similar to that shown in FIG. 11. For each option expiry, in step (4E), a formula-applied IV value is calculated by averaging the formula-applied IVs of the deltas 0.50, 0.25, 0.10, and 0.05, with respective weighted multipliers (1, 1.5, 2, 2.5) for Calls and Puts. It is important to note that Put deltas are negative, affecting the calculation. In step (4F), the software creates a chart by plotting the averaged, formula-applied IV values on the Y-axis against the days to expiry on the X-axis. All Call points are connected to form a line representing the formula-applied IV term structure for Calls, and similarly for Puts. In step (4G), the system counts the number of expiries where the formula-applied Call IV line is above the corresponding formula-applied Put IV line. This count provides insight into market sentiment and potential bullish or bearish trends. In step (4H), the difference between the formula-applied Call IVs and Put IVs for each expiry is calculated and stored. This difference, often referred to as the “surface area” between the Call and Put lines, is crucial for identifying significant shifts in market sentiment.

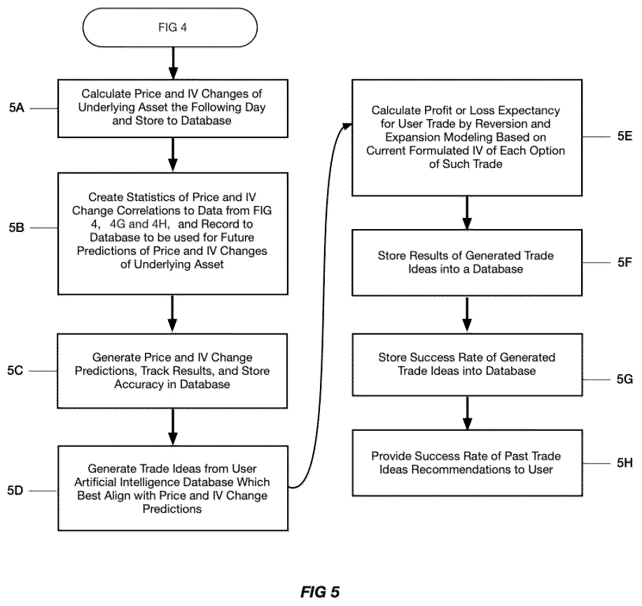

FIG. 5 is a continuation of the process described in FIG. 4, focusing on the analysis of stored data for predictive modeling and the generation of trade ideas. Referring now to FIG. 5, in step (5A), while storing data from steps (4G) and (4H) into a database, the system also stores price and implied volatility (IV) changes (2J). In step (5B), the system records statistics on correlations and pattern recognition between the formula-applied IV term structure chart (2B) and subsequent price and IV movements (2J).

For example, in step (5C), the system identifies patterns such as when, after five consecutive days of the formula-applied Put IV line being above the formula-applied Call IV line for all expiries—and the total difference (formula-applied Call IV minus formula-applied Put IV) being −200 or more negative for at least three of those days-this is followed by a day when all formula-applied Call IV lines are above the formula-applied Put IV lines for all expiries with a threshold difference of 200. In such cases, a bullish forecast is predicted for the following week. This data is stored, predictions are made, and tests are conducted to validate the correlations.

In step (5D), based on these identified correlations and the user's trading style, the system generates trade ideas. In step (5E), profit and loss expectations are calculated using the predicted price action and IV changes for each option strike. Finally, in steps (5F) and (5G), the system stores the success rates of these trade ideas, continuously updating the accuracy with each new prediction. It should be noted that predictions can be generated from a variety of statistical studies, and the invention is not limited to the specific statistical study mentioned previously.

Advantageously, the result of this process is a transformed term-structure chart that provides investors with enhanced insights into market dynamics, including the ability to: (a) predict price movements by analyzing the relative positions and divergences of the Call and Put lines, investors can anticipate potential bullish or bearish trends; (b) identify favorable option expiries, wherein the chart highlights expiries where options may be optimally priced for buying or selling based on the transformed IV values; and (c) enhance trading strategies, wherein the enriched data allows for more informed decision-making when constructing options strategies, such as spreads or directional trades.

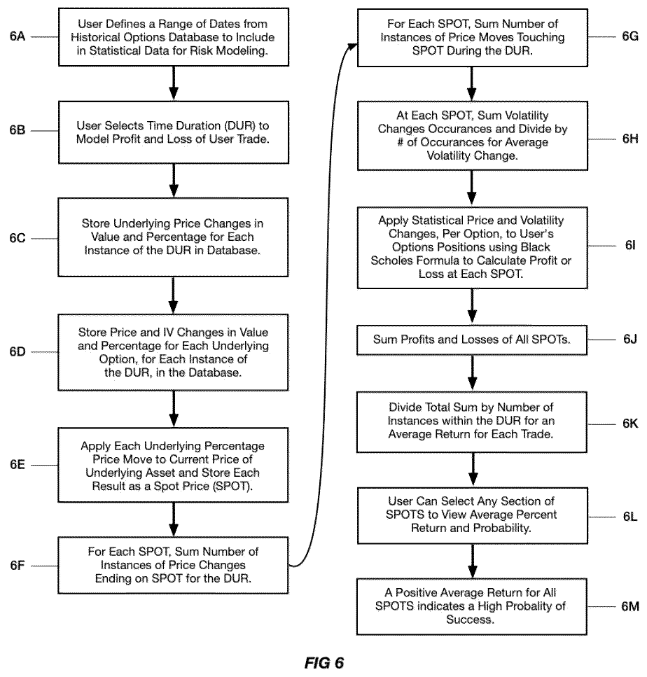

FIG. 6 illustrates another embodiment of the invention, which employs historical price and implied volatility (IV) statistics, along with an options risk profile, to determine the probability of success for an options position. Referring now to FIG. 6, In step (6A), the user defines a range of dates from a historical options database to include in the statistical data for risk modeling. This allows the user to select specific market conditions or periods of interest, such as market crashes, earnings seasons, or particular economic events. In step (6B), the user selects the duration of the trade in days (denoted as DUR). This duration represents the time frame over which the trade will be analyzed and is critical for aligning historical data with the expected holding period of the options position. In step (6C), the system stores the changes in the underlying asset's price for each duration instance within the selected date range, recording both the absolute value changes and the percentage changes. Utilizing percentage changes allows the model to be applied to any current underlying price, enhancing its flexibility and applicability.

In step (6D), the system stores the price and IV changes—both in value and percentage terms—for each underlying option over the same duration instances. This comprehensive data collection ensures that both the asset and its derivatives are accounted for in the risk analysis. In steps (6E) and (6F), the percentage changes in the underlying asset's price are used to calculate the number of instances where the price moves to specific levels, referred to as “Spot Prices of the Underlying” (SPOT), for risk modeling purposes. This step effectively maps out the historical price movements that are relevant to the current analysis. In step (6G), the system counts the number of instances where each SPOT price is reached by a price move of the underlying asset within the selected duration. This frequency count is essential for determining the statistical probability of the asset reaching various price levels. In step (6H), the system stores the percentage change in IV for each option during the selected duration and sums these values at each SPOT price per option. The total sum is then averaged by dividing by the number of instances for each SPOT price per option. This calculation provides an average IV change associated with each potential underlying price movement. In step (6I), these average percentage changes in price and IV are applied to each SPOT price using an options pricing model, such as the Black-Scholes formula, to calculate the projected price of the options positions the investor is modeling. This step translates historical statistical data into actionable pricing information for the current options position. Profits and losses are then calculated by comparing the options prices at the modeled SPOT prices to the options prices at the current SPOT. For example, if historical data indicates an average IV change of −3% for Option A and −4% for Option B when the underlying price increases by 6%, the model applies these IV changes at the 6% SPOT price using the options pricing model. The total value of all options positions is then determined, compared to their current value, and the profit or loss is calculated accordingly. This method allows the investor to model profit and loss at any SPOT price using the selected historical data.

In step (6J), the system calculates the profit and loss for each individual instance of the duration and sums them. The total profit and loss is then divided by the number of instances to compute the average return across all trades within the dataset. In step (6L), the investor can select specific SPOT price ranges to determine the probability of success for that particular price segment. This feature allows for more granular risk assessment based on targeted price movements. If the average return is positive for a significant percentage of the instances—ideally 100%—the trade is considered to have a very high probability of success, as indicated in step (6M). This statistical confidence provides the investor with a precise understanding of the trade's potential performance.

The modeling method described herein provides investors with a precise way to model risk over any selected dataset, including periods characterized by unique market conditions like crashes, volatility spikes, or significant news events. Additionally, investors can modify their trade structures—such as adjusting strike prices, expirations, or option types—with the system dynamically updating probabilities and expected returns to optimize investment decisions. This dynamic modeling capability empowers investors to tailor their strategies based on robust statistical analysis, thereby enhancing the likelihood of achieving their desired financial outcomes.

Referring now to FIG. 7, an example of a user interface for a formula-applied term structure chart in accordance with embodiments of the present invention is illustrated. In one embodiment, this interface demonstrates the advantages of the invention over prior art by providing enhanced visualization and analytical capabilities for options trading. More specifically, in prior art systems, a term structure chart typically displays a single line based on the implied volatility (IV) of 0.50 delta Calls and −0.50 delta Puts, averaging their IV for each expiry. For instance, using the S&P 500 (SPX), if the IV of a 0.50 delta Call expiring in 30 days (Days to Expiry, or DTE) is 0.20, and the IV of a −0.50 delta Put for the same DTE is 0.30, the average IV would be (0.20+0.30)/2=0.25. This average value represents the IV for that 30-day expiry. Prior art charts do not provide historical IV values for expirations, nor do they differentiate between Calls and Puts, resulting in charts that look similar from day to day and offer limited insights to investors.

However, the formula-applied term structure chart disclosed here offers several advantages. It highlights favorable expiries for buying and selling Calls and Puts, reveals time spread opportunities such as calendar spreads or diagonals, and allows for directional price predictions of the underlying asset, as well as an expected duration of time for the prediction to occur.

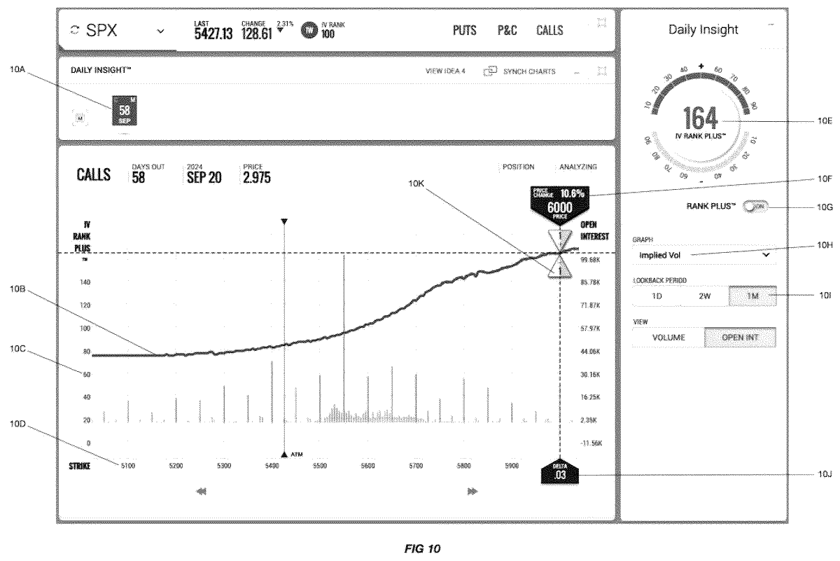

In the interface of FIG. 7, the ticker symbol from which all options data is derived is displayed prominently (7A). Interactive buttons (7B) allow the user to select specific expiries for focused analysis via the interface FIG. 10. The IV Rank, representing the formula-applied IV for each expiry, is shown (7C), which can be based on any formula the investor inputs via the interface in FIG. 11. The historical data segment used in calculations to generate the chart is indicated (7D), providing context for the data being analyzed.

The Y-axis of the chart (7E) adjusts based on the formula chosen or input by the user via the interface in FIG. 11, displaying the relevant transformed IV values in this example. The secondary Y-axis plots the open interest percentage (7F), displaying liquidity levels for each expiry, which is crucial for understanding market depth and potential trading opportunities. The numerical open interest percentage for each expiry is displayed (7G), offering quantitative insight into market participation. The formula-applied IV values for Put contracts of each expiry are shown (7H), reflecting the output of the applied formula and serving as the basis for the plotted line on the chart. Similarly, the formula-applied IV values for Call contracts of each expiry are shown via (7I).

Taking the illustrated example, the put line (7H) remains above the call line (7I) across all terms, from 22 days to 932 days, the novel chart indicating short-term bearish sentiment for this security, SPX, by a notable spike in the formulated implied volatility at 22 days to expiry. A user may measure the distance between the put line (7H) and call line (7I) to calculate the surface area between the lines. These surface area changes over time can be used to make directional predictions for the security. For instance, if the call line (7I) moves closer to or surpasses the put line (7H), this shift indicates increased buying pressure or bullish sentiment, as the formulated implied volatility on calls has risen. Advantageously, this novel chart can be used to recognize patterns to predict price and volatility movements, improving their decision-making for trade entries and exits. Additionally, the chart offers interactive historical snapshots by allowing users to move the cursor over the chart from right to left.

As described in FIG. 4, for each option expiry, a formula-applied IV value is calculated by averaging the IVs of options with deltas 0.50, 0.25, 0.10, and 0.05, applying respective weighted multipliers (1, 1.5, 2, 2.5) to Calls and Puts (noting that Put deltas are negative). These averages are plotted on the Y-axis, with days to expiry on the X-axis. Connecting these points for Calls and Puts generates separate lines for each, as detailed in step 4F. Note, this is only one example formula, and the invention does not limit the formulas which can be input by the user.

In FIG. 7, the Put line, shown with dashes, appears above the Call line, which is solid. The Put line starts higher on the left side of the chart (representing short-term expirations) and trends downward as DTE increases. Across all expiries, the Put line remains above the Call line. The area between these lines, referred to as the “surface area” or “difference,” is calculated and stored in a database for further study on price-action predictions. In this instance, the dashed Put line above the Call line signals a bearish short-term outlook. When the Call line is entirely above the Put line, it indicates bullish sentiment, especially if a large surface area or difference is present between the lines. On other days, when the lines intersect, it may indicate consolidation or neutral market sentiment.

Additional elements displayed include the open interest percentage for Puts at each corresponding expiry (7J) and the open interest percentage for Calls at each expiry (7K). The Days to Expiry (DTE) for the option chains are indicated along the axis (7L), providing a temporal reference for the data.

The predictive capabilities of this interface are significant. Snapshots of the Call and Put lines, along with open interest data, are taken and stored for analysis. Studies analyze correlations between changes in this term structure chart and subsequent price movements of the underlying asset. Quantitative research has shown that certain patterns can predict the direction of the underlying asset (up, down, or sideways) with over 90% accuracy.

Examples of stored data for such studies include the formula-applied IV levels for each expiry, other formulas applied to option attributes, the surface area between the Call and Put lines, changes in open interest percentages, the number of expiries where the Call line is above the Put line (or vice versa), sudden reversals in Call or Put line differences, and patterns where the lines move higher or lower from left to right, or where lines are elevated in the middle-term expiries. Higher Call and Put lines combined with high open interest often indicate favorable conditions for selling options, while lower levels suggest buying opportunities. Investors can improve their results by pairing months with low IV (buying) with those with high IV (selling), leveraging opportunities across multiple expiries.

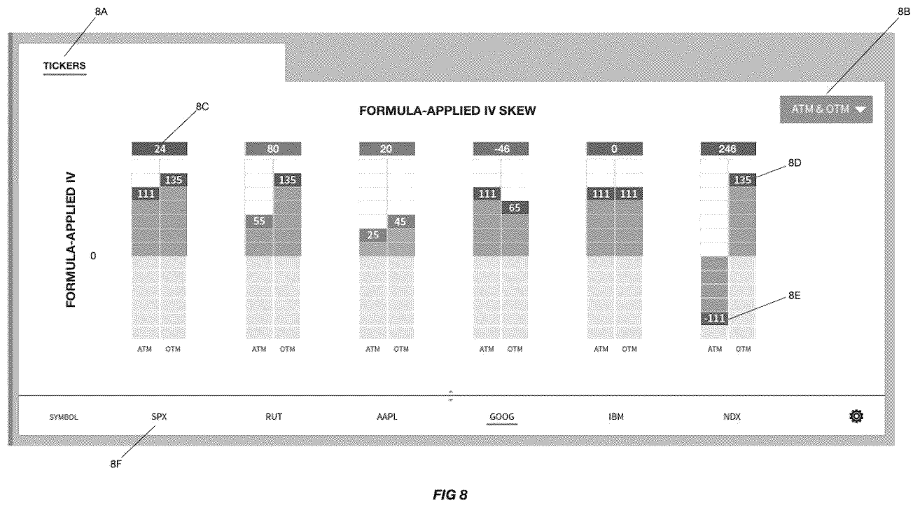

Referring to FIG. 8, an example user interface that compares the at-the-money (ATM) formula-applied implied volatility (IV) with the out-of-the-money (OTM) formula-applied IV for multiple tickers on an investor's watchlist is illustrated. In one embodiment, this interface enables investors to quickly identify potential trading opportunities within the option chain by visualizing discrepancies between ATM and OTM IV levels.

A link to access this interface is provided (8A), facilitating easy navigation for the user. The formula-applied IV for both ATM and OTM options is plotted on the chart (8B), providing a visual representation of the IV skew. The IV skew is calculated as the difference between the OTM formula-applied IV and the ATM formula-applied IV (8C). A larger skew between these strikes suggests a greater potential for reversion, increasing the probability of profitable options spreads.

The formula-applied IV values for OTM options (8D) and ATM options (8E) are displayed, allowing investors to assess the relative levels of implied volatility. By identifying significant skews, investors can consider strategies such as vertical credit or debit spreads, front and back ratio spreads, strangles, straddles, and condors, potentially capitalizing on discrepancies in implied volatility.

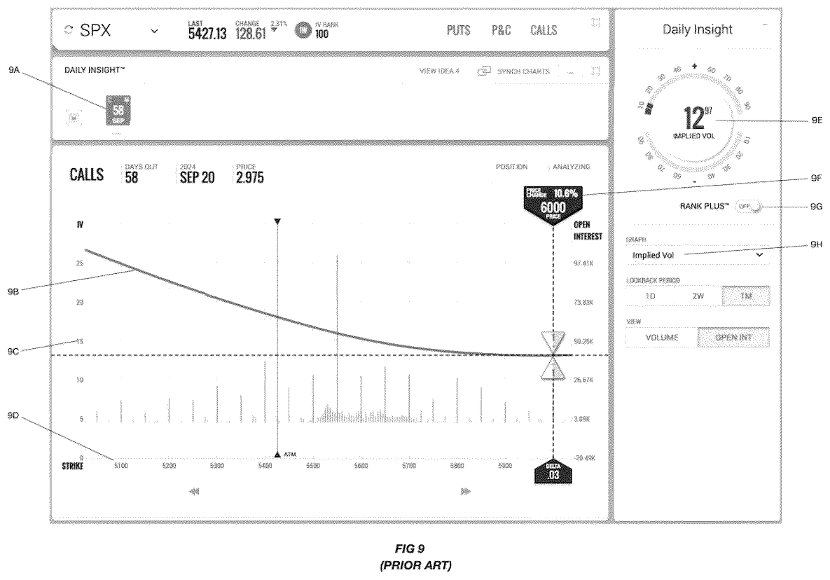

Referring to FIG. 9, there is illustrated a traditional volatility skew chart, also known as an IV smile chart, representing prior art in options analysis. This chart typically looks similar regardless of market conditions; as implied volatility rises and falls, the slope of the line changes only slightly, resulting in a smooth curve that provides limited actionable insight for investors.

The days to expiry of the selected option chain are indicated (9A), providing context for the time frame of the options being analyzed. The IV skew line (9B) connects the implied volatility of each option within the selected option chain(s), with the Y-axis representing IV and the X-axis representing the options' strike prices. Specific IV values are plotted on the chart (9C), corresponding to individual strike prices (9D). A detailed display of IV values is provided (9E), offering numerical data for precise analysis.

The strike price and the percentage difference from the current underlying price are shown (9F), assisting investors in understanding the option's moneyness. A “Rank Plus” button is in the “Off” position (9G), indicating that prior art does not apply any ranks or formulas to the IV data. A dropdown menu allows the investor to choose from various charts (9H), which may be hardcoded into the software or limited in customization. In the prior art's implementation of the IV smile chart, investors are unable to directly construct options trades.

Referring now to FIG. 10, a formula-applied volatility skew chart according to the present invention is illustrated. Traditionally, a common formula for calculating implied volatility (IV) rank is applied to the underlying asset, not its options, as follows: IV Rank=(CurrentIV−IVLow)/(IVHigh−IVLow)×100. While popular, this formula limits IV rank to a range of 0-100, which becomes ineffective when implied volatility reaches new highs, as it remains capped at 100. By applying a custom formula that extends the IV rank beyond the standard 0-100 range, both below 0 and above 100, the invention generates a transformed IV skew chart. For instance, FIG. 10 shows an IV rank of 164 in (10E). This enhanced chart reveals previously hidden volatility skews between at-the-money (ATM) and out-of-the-money (OTM) options, highlighting the advantage of allowing investors to apply custom formulas to option attributes.

The days to expiry of the selected options chain are indicated (10A). The formula-applied IV skew line is plotted (10B), with each IV value ranked as a percentage based on its one-month historical chart. This ranking transforms the traditional IV skew line, which typically slopes downward from left to right, into a line that often reverses this trend, moving upward from left to right. This reversal indicates a trading opportunity: buying ATM options and selling OTM options, which would typically be missed in traditional IV skew charts.

The IV Rank value is displayed (10C), providing a quantitative measure of the transformed IV for each option. The options' strike prices are indicated along the X-axis (10D). When an option is selected by the cursor, the formula-applied IV value is shown (10E), allowing for detailed examination of individual data points. An “On” switch indicates that the formula is being applied to the IV of the options (10G). The chart specifies which graph is being displayed (10H), as numerous graphs can be drawn by inputting formulas into the interface in FIG. 11. The historical data used in calculating the formula-applied IV value is indicated (10I), providing transparency into the data transformation.

The option's delta is shown (10J), offering additional information on the option's sensitivity to changes in the underlying asset's price. Tools for constructing trades are provided (10K), allowing investors to execute buy and sell actions directly from the chart based on the insights gained.

Advantageously, by identifying these skews, investors can increase the potential profitability of each trade, providing long-term advantages. These skews also improve the probability of success for each trade. When these skews are not visible, as in prior art, investors may inadvertently enter trades with unfavorable IV skews, putting them at a disadvantage.

Referring now to FIG. 11, an example of a formula input interface designed to enable investors to create and apply custom formulas to various options attributes, including but not limited to the Greeks, implied volatility (IV), option prices, and days to expiration is illustrated. The interface (11A) provides a field where investors can input their formulas, which are then applied to the options attributes to generate outputs that can be charted across different embodiments of the invention.

In the provided example, the formula “Theta divided by Option Price divided by Gamma divided by Speed” (Theta/Option Price/Gamma/Speed) is employed to identify favorable options to sell with minimal directional risk. By dividing Theta by the Option Price, the formula converts Theta into a relative decay rate, effectively normalizing it relative to the option's price. Further dividing by Gamma and Speed targets options where the decay rate is least affected by movements in the underlying asset's price. Specifically, Gamma measures the rate of change in Delta (which represents directional risk), while Speed measures the rate of change in Gamma relative to changes in the underlying price. Options that exhibit the highest output from this formula indicate a high decay rate with minimal risk, presenting an advantageous scenario for investors looking to sell options.

The interface also includes a section (11B) featuring preset formulas that investors can select as a starting point for building their own formulas. Additionally, an expanded interface (11C) is available, where the “Basic” tab offers preset formulas for quick selection, and the “Very Advanced” tab provides enhanced flexibility for investors to input and customize their own formulas. Mathematical operators, such as division or multiplication, can be added to the formulas through interactive elements like buttons or dropdown menus (11D), allowing users to expand or refine their formulas as needed.

To facilitate ease of use and efficiency, the interface provides tools (11E and 11F) that allow investors to save their custom formulas. This functionality enables the creation of preset buttons or shortcuts within the interface, granting investors quick access to their preferred formulas for future analyses. By offering this level of customization and personalization, the formula input interface empowers investors to tailor their analytical approaches to their specific trading strategies and preferences. By transforming traditional options data into actionable intelligence through customized formula application, the invention provides a substantial improvement over prior art systems, which lack such options.

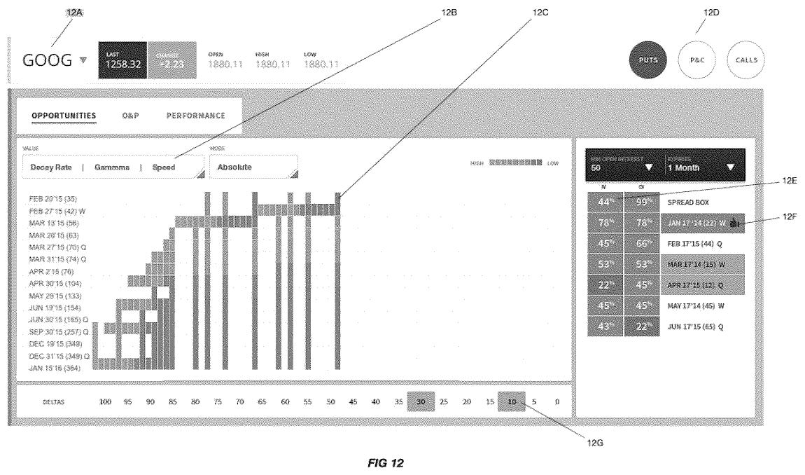

Referring to FIG. 12, an example interface displaying the formula output in a grid format is illustrated. In this embodiment, the formula “(Decay Rate/Gamma/Speed)” is applied and charted, assisting the investor in quickly identifying options to sell with minimal directional risk. Each grid box represents an option with its corresponding formula output, color-coded for rapid assessment.

The underlying ticker symbol is displayed prominently (12A), indicating the asset for which the options data is presented. A dropdown menu allows the investor to select built-in or custom formulas they have created (12B), providing flexibility in analysis. The color-coded representation of the formula output for each option is shown within the grid (12C), with colors corresponding to the magnitude of the formula output.

Controls enable the grid output to display Puts, Calls, or both (12D), allowing the investor to focus on specific option types. The interface displays the implied volatility value and open interest percentage for each expiry (12E), providing additional context for the options presented. The expiry selected by the user is indicated (12F), focusing the analysis on a particular time frame. Filters are available to adjust the delta range of the chart (12G), enabling investors to concentrate on options within specific delta parameters that align with their trading strategies.

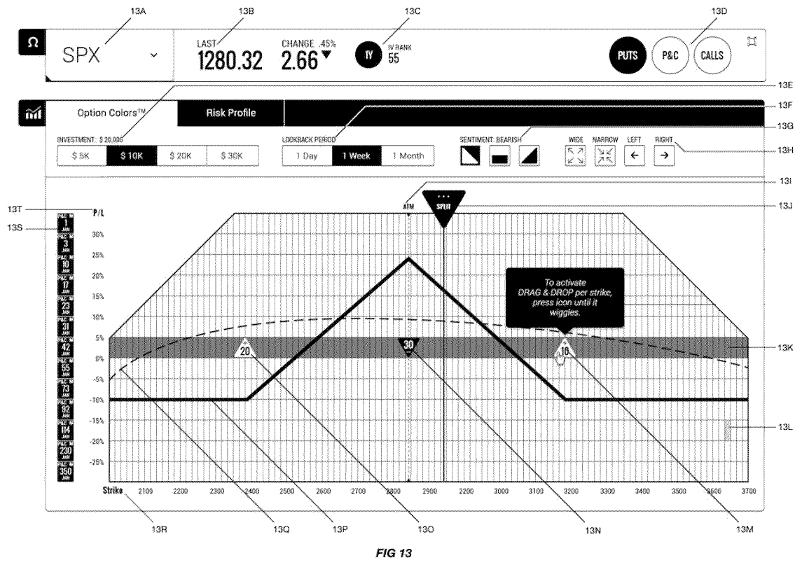

Referring to FIG. 13, a grid interface that includes a superimposed risk profile, enabling investors to construct trades while interacting with their respective formula outputs is illustrated. Each grid box represents an option based on the formula output, and the invention generates trade ideas that can be added to the chart automatically or with minimal user input.

The underlying ticker symbol is displayed (13A), along with the last price of the ticker (13B), providing immediate reference to the asset's current market value. The rank of the ticker based on selected criteria is shown (13C), offering insight into its relative standing according to the investor's parameters. Selectors allow the investor to chart Puts, Calls, or both (13D), tailoring the options displayed.

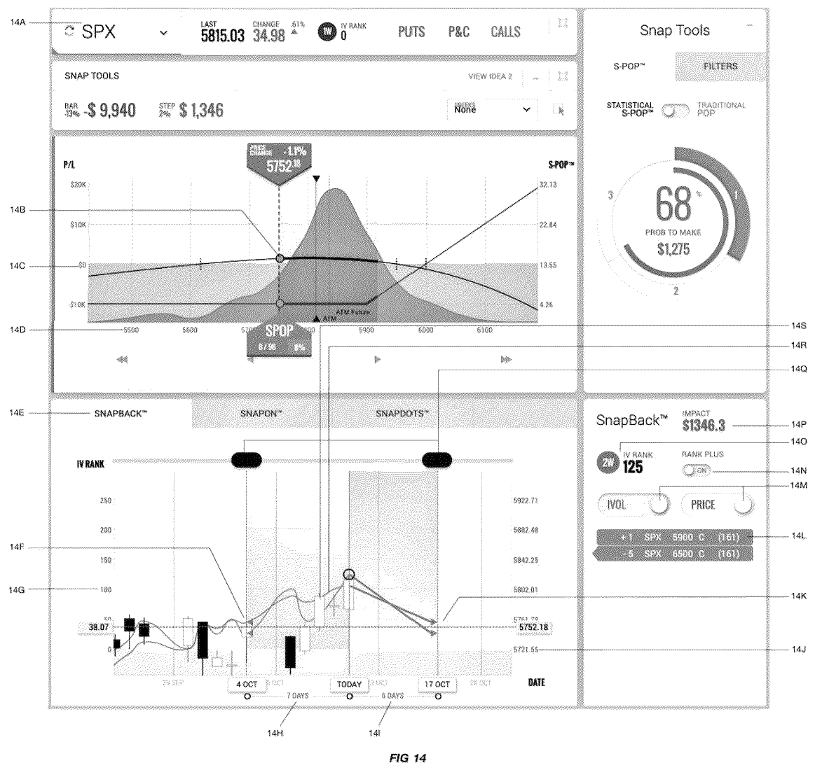

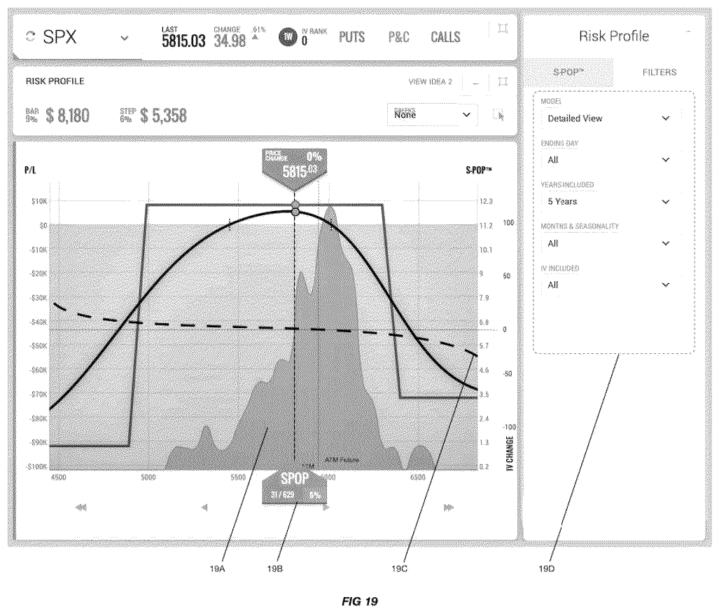

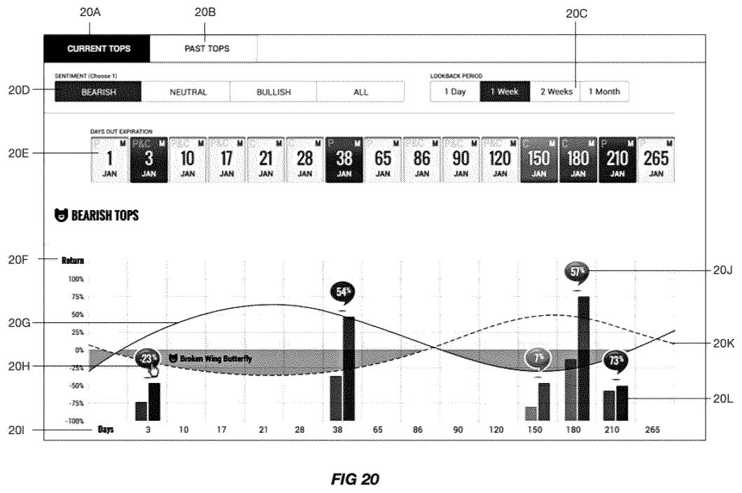

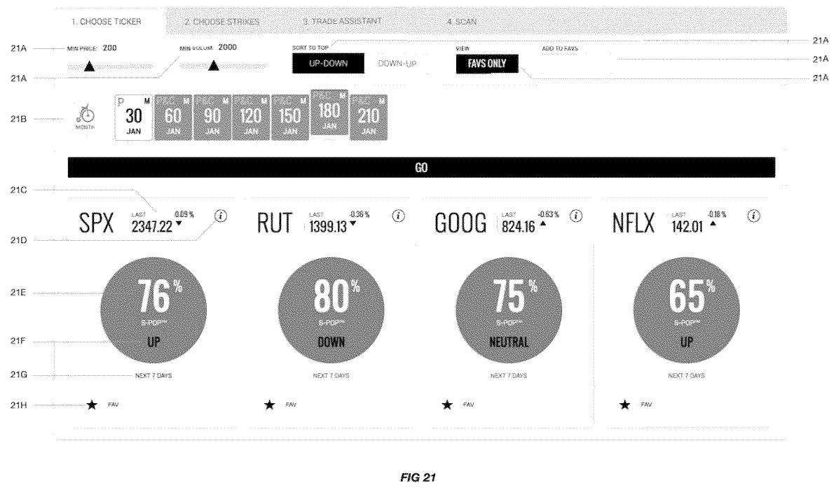

An input field allows the investor to specify the investment amount for a trade (13E), affecting the number of contracts generated and helping to manage capital allocation. Presets of historical options data can be applied to the formula's output (13F), facilitating analysis based on historical trends. Buttons are available to generate trade ideas based on bearish, neutral, or bullish sentiment (13G), with strikes optimized according to the invention's algorithms. For example, a directional prediction (i.e. bearish, neutral, bullish) for the security can be made by identifying a significant change in surface area between the formulated Call and Put IV lines, as described in the algorithms of FIG. 4 and user interface FIG. 7. Volatility predictions can be generated using the system of FIG. 5 and user interface FIG. 21. If bullish sentiment is detected, a corresponding trade can be structured with the system of FIG. 3 and interface FIG. 7 by selecting an expiry, such as one showing a spike in formulated IV along with high open interest. The system of FIG. 3 and interface FIG. 10 assist in identifying specific option strikes to buy (e.g., low formulated IV) and sell (e.g., high formulated IV), with high and low levels visually indicated by color-coding on the grid (13L). Additional strategies can be drawn from the user's trading database (2L), using artificial intelligence (3J) to generate optimized trade ideas. Estimated profit and loss calculations for the trade are available via the systems of FIG. 3 and interfaces FIGS. 14-17. Statistical studies from system FIG. 5 and interfaces FIGS. 19-20 help determine the trade's profitability. Finally, the capital allocation for the trade is set using (13E).

Navigation controls enable the investor to move the risk profile on the grid (13H), adjusting positions as needed. The current price of the underlying asset is indicated (13I), serving as a reference point for constructing trades. A feature allows splitting the risk profile into parts for adjustment on the grid (13J), providing flexibility in modifying trade components.

The option chain corresponding to the risk profile is displayed (13K), offering detailed information on each option involved. The color-coded formula output is overlaid on the grid (13L), enhancing visual interpretation. Fields display the number of long option contracts (13M) and short option contracts (13N), both of which can be adjusted by the investor. Additional legs of the options spread can be included (13O), enabling complex trade constructions.

The risk profile at expiration is shown (13P), illustrating potential outcomes based on the constructed trade. The current risk profile is also displayed (13Q), reflecting real-time status. The X-axis shows options strike prices (13R), with columns matching strikes; in other embodiments, deltas may be used. Interactive buttons control which option chains are shown on the grid (13S), with rows representing expiries. The Y-axis shows profit and loss from the risk profile (13T), aiding in assessing potential returns and risks.

Referring now to FIG. 14, an interface providing real reversion modeling, combining a historical formula output chart with a risk profile chart is illustrated. A formula applied to the implied volatility of each option analyzes risk, and a historical chart plots the formula's output for each respective option. Users can select a past formula output and future date to assess profit and loss impacts using options pricing models like Black-Scholes. The interface also allows toggling between standard IV values and formula-applied IV values.

The underlying ticker is displayed (14A), and the spot price selected by the user is indicated (14B), serving as the basis for modeling. The Y-axis shows the position's profit or loss (14C), while the X-axis displays strike prices (14D). The selected software application is noted (14E), contextualizing the interface within the suite of tools.

The selected past date and IV values applied to the future are shown (14F), allowing users to model scenarios based on historical data. Users can select past dates for all options contracts simultaneously using a slider (14Q) or adjust individual contract dates by moving a specific arrow (14F) to an alternate date, offering investors greater control over reversion modeling. The IV Rank is displayed on the Y-axis (14G), providing a measure of the formula-applied IV. Users can select the number of past days for analysis (14H) and the number of future days for risk modeling (14I). A secondary Y-axis shows the underlying price (14J), providing additional context.

The formula output for the future date is plotted (14K), and specific options shown on the chart are indicated (14L). Preset charting options, such as IV and price, are available (14M) for quick configuration. The IV Rank for a two-week look-back period is displayed (14O), offering insight into recent trends. The profit and loss impact from replacing future theoretical IVs with real past IVs at the selected spot price is calculated and shown (14P).

Sliders allow users to select past and future dates (14Q), enabling dynamic adjustments to the modeling period. A line represents the formula output over time (14R), and a superimposed price chart of the underlying asset is included (14S), providing comprehensive visual analysis.

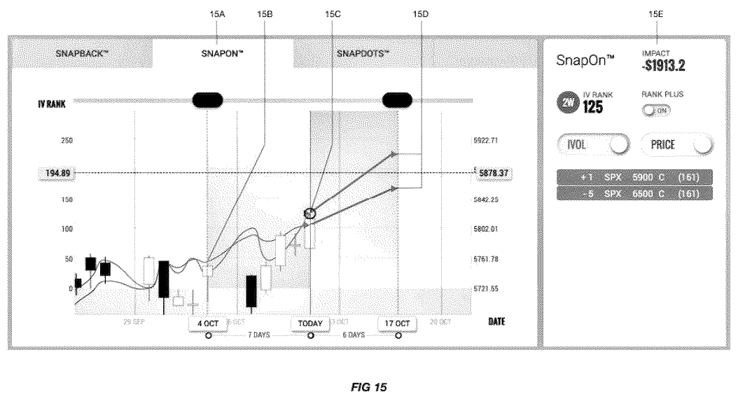

Referring to FIG. 15, an interface modeling profit and loss based on a continuation pattern of the formula output is illustrated. This scenario is useful if the investor believes the underlying price trend will persist.

The selected application tab is displayed (15A), indicating the context within the software suite. The formula output applied to past IV values is shown (15B), serving as a historical reference. The formula output on a more recent date is indicated (15C), providing a baseline for comparison. Users can select recent dates for all options contracts simultaneously using a slider (14Q) or adjust individual contract dates by moving a designated arrow (15C) to a different date, giving investors enhanced control over continuation modeling. The future formula output based on the continuation pattern is plotted (15D), projecting potential movements. The profit and loss impact at the spot price selected by the user is calculated and displayed (15E), assisting in evaluating the potential trade.

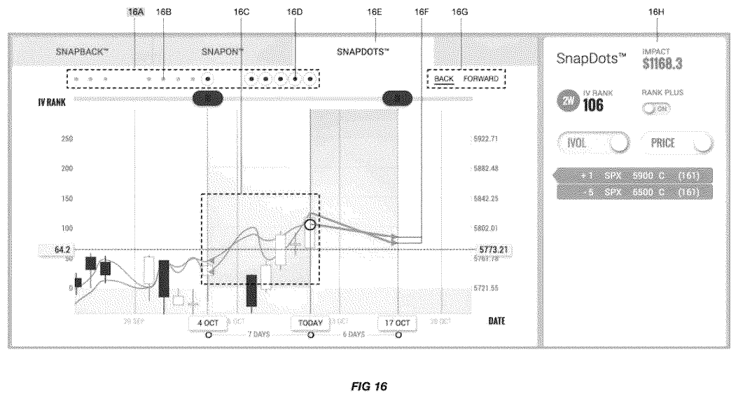

Referring now to FIG. 16, an interface combining both reversion and continuation patterns, weighted by normalizing options attributes across multiple days is illustrated. The user can select or exclude specific dates, allowing for greater control over the dataset used in calculations.

Interactive dots represent dates (16A); users can select or deselect these to include or exclude them from the dataset. Non-selected dates are indicated visually (16B), while groups of selected dates are highlighted (16C). Reference dates for individual options contracts can be adjusted independently, as illustrated in FIG. 14 and FIG. 15, to enable more precise modeling. A selected date is emphasized (16D), allowing precise control over the data. The selected application tab is displayed (16E).

The weighted implied volatility output of each option is shown (16F), reflecting the combined data from the selected dates. A selector allows the user to choose between backward (reversion) or forward (continuation) modeling (16G). The profit and loss impact from the weighted reversion or continuation is calculated and displayed (16H), assisting in assessing the potential outcomes of different scenarios.

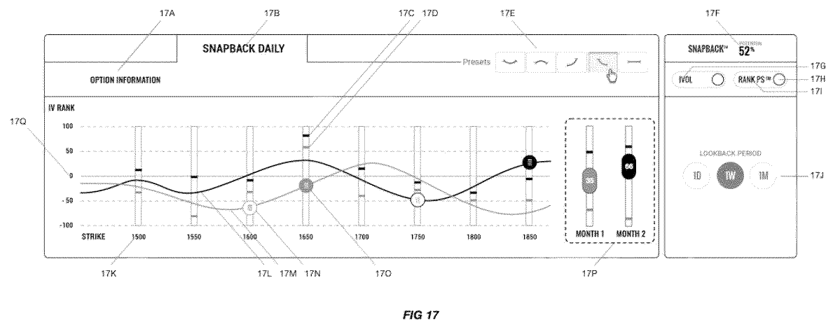

Referring now to FIG. 17, an example user interface resembling an IV smile chart that operates like a sound equalizer is illustrated. It displays the high, low, mean, and current formula output over a look-back period, allowing users to model reversion or continuation for individual or grouped option strikes. The interface also permits reversion/continuation modeling for selected option chains and provides preset buttons to adjust the shape of the IV smile.

An area is provided for displaying option data such as price and delta (17A), offering additional context. The application tab selection is indicated (17B). The historical high of the formula output is shown (17C), along with the historical low (17D), providing reference points for the range of values. Preset curves are available to modify the current IV curve (17E), allowing quick adjustments based on common patterns.

The profit and loss impact from changes in IV per option is calculated and displayed (17F). A formula selector with drill-through functionality is included (17G), enabling detailed exploration of different formulas. A toggle allows users to switch between value or ranked output of the formula (17H), providing different analytical perspectives. The selected formula from the drill-through interface is indicated (17I).

The look-back period for historical data applied to the formula is specified (17J). Option strike prices are plotted along the X-axis (17K). Formula output lines for different months are displayed (17L/M), with the Y-axis representing IV Rank and the X-axis representing strike prices. Handles allow users to adjust reversion or continuation modeling for short and long positions (17N/O). Controls for month display, including high, low, mean, and current IV, are provided (17P), enabling comprehensive reversion/continuation modeling for option chains.

This tool is particularly useful for modeling large skews, such as those occurring during market crashes or earnings seasons, facilitating risk analysis in such scenarios.

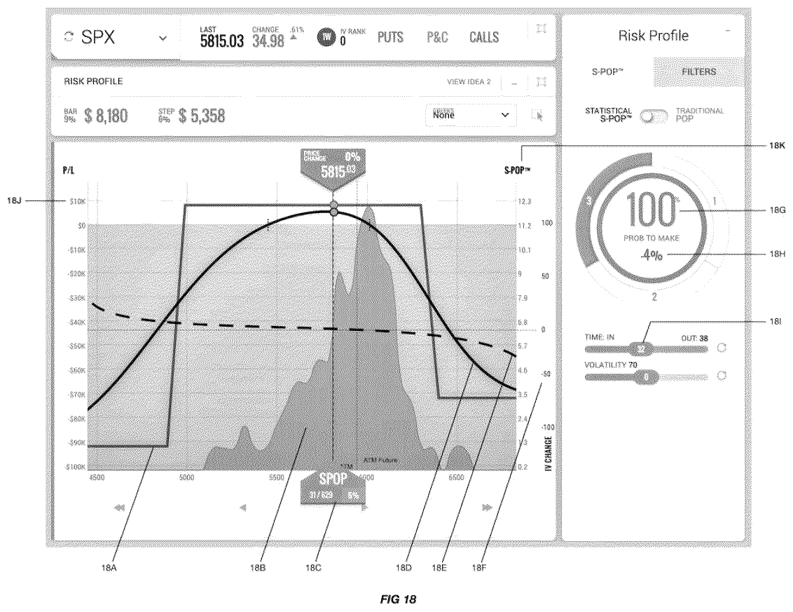

Referring to FIG. 18, an interface that integrates statistical analysis into options risk modeling, providing investors with insights on volatility and price movements per strike is illustrated. This allows for a better understanding of risk exposure under various scenarios like market crashes, earnings releases, or economic downturns. Investors can modify positions to maximize expected returns based on statistical data, helping to identify profitable trades or avoid likely losses.

The risk profile of options at expiration is displayed (18A), illustrating potential outcomes. A statistical distribution histogram shows underlying price movements, with the Y-axis representing relative frequency and the X-axis representing underlying prices (18B). Data indicating the total number of price moves tested (e.g., 629), instances at the spot price (e.g., 31), and the probability of ending at the spot price (e.g., 5%) are provided (18C).

The profit and loss at each spot price is calculated and shown (18D), offering detailed financial projections. The relative implied volatility change per option strike is displayed (18E), with the Y-axis indicating relative IV change (18F). The probability calculated from the selected portion of the histogram is shown (18G). The average return per test from the dataset is indicated (18H), providing an expected performance metric. The number of days in the trade is specified (18I), relevant for time-based risk assessment. The Y-axis for profit and loss corresponding to the risk profile is displayed (18J). The probability of profit for each spot price is calculated and shown (18K), aiding in decision-making.

When all statistical data is included in the risk modeling, and the average return is negative, as indicated by (18H), the options position has a statistically high likelihood of losing money over the trade duration (18I). This risk is obscured in prior art, leaving users unaware that their positions are likely to incur losses. Conversely, investors may also miss out on trades with a high probability of success because prior systems fail to present this information. This invention helps investors identify profitable opportunities and avoid losing trades.

Referring now to FIG. 19, an interface for selecting historical statistical data to be applied in risk modeling, using a historical options database spanning the last five years is illustrated. It should be understood that five years is one of many custom options, and the time period or years included may vary depending on the preferred dataset the user selects. This tool allows investors to customize the historical data used in their risk models, enabling analysis based on specific market conditions or time periods.

In one embodiment, a statistical distribution histogram is displayed (19A), providing a visual representation of historical price movements. Statistics at each spot price are provided (19B), offering granular insights. The relative implied volatility change for each option is shown (19C). An interface for selecting historical data for risk modeling is included (19D), referencing earlier components such as (2F), (2A), (2E), and (2J).

Referring to FIG. 20, an interface for a trade idea generator powered by an artificial intelligence module (as referenced in elements 2H, 3J, 2M, and 2L). This system creates and tests trades based on the principles disclosed herein. The application generates option trades, calculates formula-applied IV values for all option strikes, analyzes reversion and continuation patterns, and presents the user with the most favorable trade opportunities.

A tab for generating top trade ideas is provided (20A), offering quick access to the feature. Statistical data of past trade ideas, such as win rates and returns, are displayed (20B), aiding in strategy evaluation. The look-back period for historical data used in generating trade ideas is indicated (20C). Radio buttons allow the user to select trade sentiment—bearish, neutral, or bullish (20D)—aligning with their market outlook. Option-chain selector buttons for days to expiration are available (20E), allowing time frame customization.

The Y-axis shows potential returns of trade ideas (20F), providing a visual comparison. The formula-applied Call IV line is displayed (20G), along with the formula-applied Put IV line (20K), forming the basis of the term structure chart. Icons representing trade ideas are clickable for trade construction (20H, 20J). The X-axis represents days to expiration (20I). A bar chart shows relative open interest for Puts (left) and Calls (right) (20L), indicating market activity.

These trade ideas are visually overlaid onto the formula-applied term structure chart (FIG. 7). The user can initiate a trade by simply clicking the trade idea icon (20H), streamlining the process from analysis to execution.

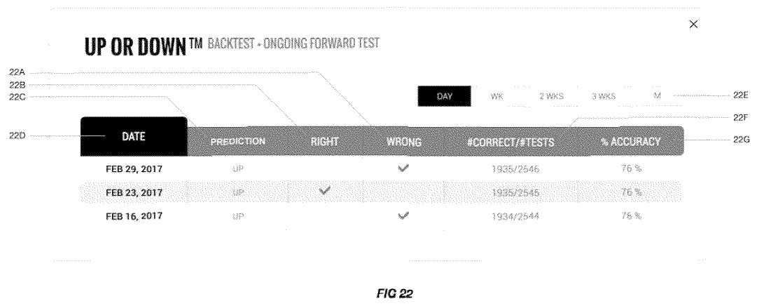

Referring now to FIG. 21, a prediction interface for forecasting changes in implied volatility over a specified time frame is provided. In one embodiment, it calculates the probability of IV moving up or down a specified amount based on the methodologies described in FIGS. 3, 4, and 5. Filters and navigation buttons are available (21A), such as price/volume filters and sorting options, for data customization. Option-chain selector buttons for days to expiration are provided (21B), tailoring the analysis period. Price data for the underlying ticker is displayed (21C), offering essential context. A button links to a table tracking prediction accuracy, as shown in FIG. 22 (21D).

The statistical probability of the IV prediction is indicated (21E), aiding in risk assessment. The direction of the predicted IV change (up or down) is displayed (21F), along with the time frame for the prediction (21G). A bookmark button allows users to save favorite tickers (21H), enhancing usability.

Referring to FIG. 22, a table tracking the accuracy of implied volatility predictions made by the system is provided. Counts of “Wrong” predictions (22A) and “Right” predictions (22B) are displayed, providing transparency into the system's performance. The direction of the IV prediction (up or down) for each entry is indicated (22C), along with the date of each prediction (22D). Radio buttons allow users to view prediction results over various durations, such as one day or one week (22E). The number of tests conducted and the number of successful predictions are shown (22F), and the accuracy rate of the predictions is calculated and displayed as a percentage (22G).

This tracking mechanism allows users to assess the reliability of the system's predictions, informing their decision-making process and enhancing confidence in the analytical tools provided by the invention.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

The present invention provides a concrete technological solution that enhances computer-implemented systems used in options trading analysis. By applying customized formulas to options attributes such as implied volatility and Greeks, the invention transforms traditional options data into new, non-abstract forms that yield actionable insights. This transformation is achieved through specific data processing techniques and innovative user interfaces that improve the functionality of computers in performing options analysis. The system's ability to generate real reversion modeling, statistical risk assessments, and personalized trade recommendations through artificial intelligence represents a technological advancement over prior art.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. In other words, the terminology and phraseology used in this description and the abstract are for illustrative purposes and should not be considered limiting. Therefore, while exemplary illustrative embodiments of the invention have been described, numerous variations and alternative embodiments will occur to those skilled in the art. Such variations and alternative embodiments are contemplated, and can be made without departing from the spirit and scope of the invention.

What is claimed is:

1. A computer-implemented method for enhancing options trading, comprising steps:
(a) receiving, by a computing system, options data including options attributes for a plurality of options contracts;
(b) calculating, by the computing system, options attributes including implied volatility values and Greeks for the plurality of options contracts using an options pricing model;
(c) applying, by the computing system, a user-defined or preset formula to at least one options attribute to generate transformed options data;
(d) storing, by the computing system, the transformed options data in a database;
(e) generating, by the computing system, at least one graphical user interface that displays the transformed options data, wherein the interface includes interactive elements allowing a user to construct options strategies, visualize and analyze the transformed options data across different options contracts and expirations;
(f) analyzing, by the computing system, patterns in the transformed options data to identify trading opportunities and predict market movements.

2. The method of claim 1, further comprising step (g) providing, by the computing system, trade recommendations or strategies to the user based on the analysis of the transformed options data.

3. The method of claim 1, wherein the at least one graphical user interface is a formula-applied term structure chart displaying a put line and a call line, wherein the put line and the call line are displayed separately allowing the user to predict the direction of an option contract, the plurality of option contracts, or the underlying security.

4. The method of claim 1, wherein the at least one graphical user interface is a statistical analysis interface configured to display a risk profile superimposed over historical price changes over a predetermined time period allowing the user to determine if a particular trade was profitable over the predetermined time period's price and volatility moves.

5. The method of claim 4, wherein the statistical analysis interface comprises:
a statistical distribution histogram showing underlying price movements;
a first Y-axis representing relative frequency and a X-axis representing underlying prices;
data plots indicating the total number of price moves tested at a number of instances at a spot price;
a profit and loss at each spot price is calculated and plotted;
a second Y-axis indicating relative IV change;
a probability calculated from the selected portion of the histogram plotted; and
wherein the average return per test from the dataset is indicated providing an expected performance metric.
